(19) United States
(12) Patent Application Publication
(10) Pub. No.: US 2019/0191072 A1
(43) Pub. Date: Jun. 20, 2019

(54) IMAGE CAPTURING APPARATUS

(71) Applicant: CANON KABUSHIKI KAISHA, Tokyo (JP)

(72) Inventor: Taro Takita, Kawasaki-shi (JP)

(21) Appl. No.: 16/216,616

(22) Filed: Dec. 11, 2018

(30) Foreign Application Priority Data
Dec. 19, 2017 (JP) 2017-243011

(51) Int. Cl. H04N 5/235; H04N 5/355

(52) U.S. Cl. CPC H04N 5/2355; H04N 5/35581; H04N 5/2356

(57) ABSTRACT

The aspect of the embodiments is directed to an apparatus capable of reducing a delay by predicting a timing at which an image is to be retrieved from a timing signal. The apparatus configured to capture an image of a target object repeatedly at a first timing includes an image sensor configured to acquire image data of the target object, a control unit configured to control driving of the image sensor, and an acquisition unit configured to acquire a second timing at which the target object is to be processed repeatedly, and the control unit controls the driving of the image sensor based on an interval between first timings and an interval between second timings.

### BACKGROUND OF THE INVENTION

### Field of the Invention

The aspect of the embodiments relates to an image capturing apparatus linked with an external environment and a method of controlling the same.

### Description of the Related Art

There are methods for capturing an image of a target in an image capturing system, and examples of such methods include a control method by which a still image is acquired according to a timing signal input from an external apparatus while image data output from an image sensor is acquired as a continuous moving image. Such a control method is used in factory automation (hereinafter, sometimes referred to as “FA”) and academic applications. During the control, a delay with respect to an intended timing to retrieve an image sometimes occurs due to an output timing of the timing signal or a method of driving the image sensor.

Further, there are cases in which a plurality of images of different exposures is combined or a long exposure is required in order to respond to various subject conditions. In such cases, the delay can be further extended.

Although there are methods for overcoming a timing delay in which timings to acquire images for use in combining are set to different timings as discussed in Japanese Patent Application Laid-Open No. 2015-056807, such methods are sometimes not suitable in the cases of acquiring images of different exposures. For example, there is a case of acquiring image data by repeating resetting and reading operations at suitable synchronization timings. The gravity center (corresponding to acquisition timing) of an exposure period is defined as the center of resetting and reading timings, and the reading timing is fixed with respect to the synchronization timing for each piece of image data. In this case, the interval of the gravity center of the exposure between images is longer from a high exposure image to a low exposure image than from the low exposure image to the high exposure image. Specifically, since the acquisition timings of the high exposure image and the low exposure image are temporally separated, it is not suitable to combine the images acquired in this order.

A technique for reducing a delay by predicting an actual timing at which an image is to be retrieved from a timing signal is sought.

### SUMMARY OF THE INVENTION

According to an aspect of the embodiments, an apparatus configured to capture an image of a target object repeatedly at a first timing includes an image sensor configured to acquire image data of the target object, a control unit configured to control driving of the image sensor, and an acquisition unit configured to acquire a second timing at which the target object is to be processed repeatedly, wherein the control unit controls the driving of the image sensor based on an interval between first timings and an interval between second timings.

Further features of the disclosure will become apparent from the following description of exemplary embodiments with reference to the attached drawings.

### BRIEF DESCRIPTION OF THE DRAWINGS

FIG. 1 illustrates an entire configuration in a first exemplary embodiment.

FIG. 2 illustrates a system configuration in an exemplary embodiment.

FIG. 3 is a timing chart illustrating a high dynamic range (HDR) driving mode.

FIG. 4 is a flowchart illustrating an operation in the first exemplary embodiment.

FIGS. 5A and 5B illustrate an operation of a cutter of an examination table and trigger points in an exemplary embodiment.

FIGS. 6A and 6B are timing charts illustrating an operation in the first exemplary embodiment.

FIG. 7 illustrates an entire configuration in a second exemplary embodiment.

FIGS. 8A, 8B, 8C, and 8D are timing charts illustrating an operation in the second exemplary embodiment.

### DESCRIPTION OF THE EMBODIMENTS

Elements of one embodiment may be implemented by hardware, firmware, software or any combination thereof. The term hardware generally refers to an element having a physical structure such as electronic, electromagnetic, optical, electro-optical, mechanical, electro-mechanical parts, etc. A hardware implementation may include analog or digital circuits, devices, processors, applications specific integrated circuits (ASICs), programmable logic devices (PLDs), field programmable gate arrays (FPGAs), or any electronic devices. The term software generally refers to a logical structure, a method, a procedure, a program, a routine, a process, an algorithm, a formula, a function, an expression, etc. The term firmware generally refers to a logical structure, a method, a procedure, a program, a routine, a process, an algorithm, a formula, a function, an expression, etc., that is implemented or embodied in a hardware structure (e.g., flash memory, ROM, EPROM). Examples of firmware may include microcode, writable control store, micro-programmed structure. When implemented in software or firmware, the elements of an embodiment may be the code segments to perform the necessary tasks. The software/firmware may include the actual code to carry out the operations described in one embodiment, or code that emulates or simulates the operations. The program or code segments may be stored in a processor or machine accessible medium. The “processor readable or accessible medium” or “machine readable or accessible medium” may include any medium that may store information. Examples of the processor readable or machine accessible medium that may store include a storage medium, an electronic circuit, a semiconductor memory device, a read only memory (ROM), a flash memory, a Universal Serial Bus (USB) memory stick, an erasable programmable ROM (EPROM), a floppy diskette, a compact disk (CD) ROM, an optical disk, a hard disk, etc. The machine accessible medium may be embodied in an article of manufacture. The machine accessible medium may include information or data that, when accessed by a machine, cause the machine to perform the operations or actions described above. The machine accessible medium may also include a program code, an instruction or instructions embedded therein. The program code may include a machine readable code, an instruction or instructions to perform the operations or actions described above. The term “information” or “data” here refers to any type of information that is encoded for machine-readable purposes. Therefore, it may include a program, a code, data, a file, etc.

All or part of an embodiment may be implemented by various means depending on applications according to particular features, functions. These means may include hardware, software, or firmware, or any combination thereof. A hardware, software, or firmware element may have several modules coupled to one another. A hardware module is coupled to another module by mechanical, electrical, optical, electromagnetic or any physical connections. A software module is coupled to another module by a function, a procedure, a method, a subprogram, or a subroutine call, a jump, a link, a parameter, a variable, and argument passing, a function return, etc. A software module is coupled to another module to receive variables, parameters, arguments, pointers, etc. and/or to generate or pass results, updated variables, pointers, etc. A firmware module is coupled to another module by any combination of hardware and software coupling methods above. A hardware, software, or firmware module may be coupled to any one of another hardware, software, or firmware module. A module may also be a software driver or interface to interact with the operating system running on the platform. A module may also be a hardware driver to configure, set up, initialize, send and receive data to and from a hardware device. An apparatus may include any combination of hardware, software, and firmware modules.

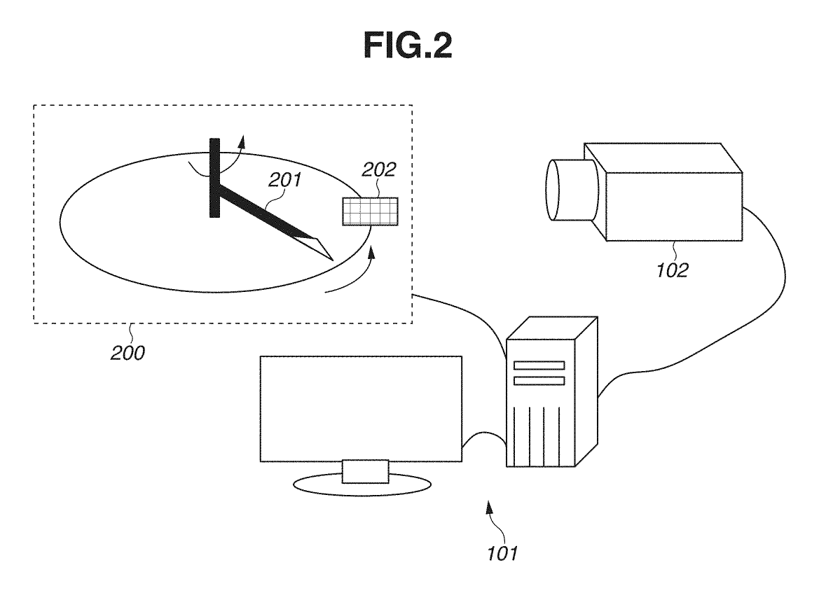

A first exemplary embodiment of the disclosure is described with reference to the drawings. FIG. 2 illustrates an example of a system in the present exemplary embodiment. In all the drawings, the same reference numbers are given to those having similar functions to avoid duplicated description thereof. Each element is not limited to any description of an exemplary embodiment and can be modified as needed.

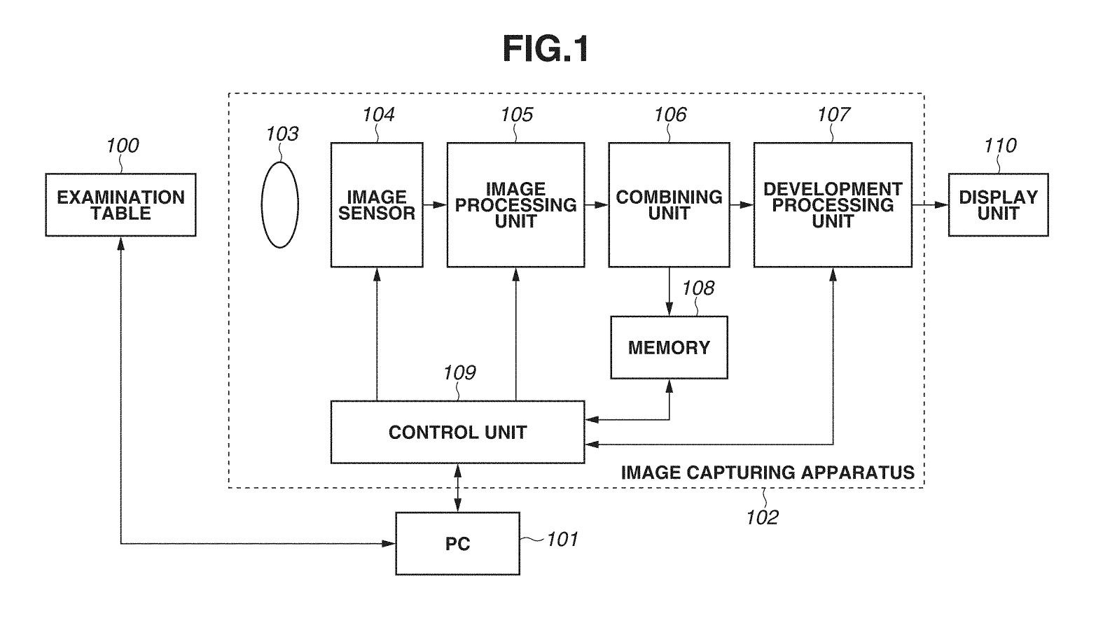

The following describes the entire configuration of an image capturing system including an image capturing apparatus 102 in the present exemplary embodiment, with reference to the detailed block diagram illustrated in FIG. 1.

An examination table 100 is where an image capturing target is to be placed. The examination table 100 includes a stage for changing the position of an image capturing target and an electronic device such as a cutter for cutting the target. The examination table 100 can further include a heater for heating the target and a draft for scavenging an atmosphere. Each electronic device attached to the examination table 100 is externally operable, and a communication port for operating each electronic device and a control unit for controlling each electronic device are also provided.

An external apparatus 101 is, for example, a personal computer (hereinafter, sometimes referred to as “PC”). The PC 101 controls the entire image capturing system and supplies a control signal, setting information, etc. to the examination table 100 and blocks of the image capturing apparatus 102 described below. While each control target is expected to be wire-connected using a local area network (LAN) cable, a universal serial bus (USB) cable, etc., each control target can be wirelessly connected using Wi-Fi, etc. or can be connected with each device via a network. The PC 101 can include a mouse and a keyboard as an input unit as in a commonly-employed configuration, or can include a joystick, a dedicated switch board, and a trackball, or can include a touch panel such as a tablet PC.

The image capturing apparatus 102 captures an image of a target placed on the examination table 100 and outputs the captured image as image data. While an output destination of the image data is a display unit 110 or the PC 101, the image data can be output to and saved in a storage unit such as a memory card included in the image capturing apparatus 102 or can be output to a storage on the network or cloud.

An imaging lens 103 corresponds to an image capturing optical system that converges subject light to form a subject image. The imaging lens 103 is a lens group including a zoom lens and a focus lens. The imaging lens 103 can be configured to be removable from the main body of the image capturing apparatus 102. The imaging lens 103 includes a shutter mechanism (not illustrated), a diaphragm mechanism (not illustrated), and an anti-vibration mechanism (not illustrated). Types of the diaphragm mechanism include a type of controlling an aperture diameter with a plurality of diaphragm blades, a type of inserting and removing a plate including a plurality of holes of different diameters, and a form of inserting and removing an optical filter such as a neutral density (ND) filter, and any type can be employed by which the amount of exposure is adjusted.

An image sensor 104 includes a charge-coupled device (CCD) image sensor or complementary metal oxide semiconductor (CMOS) image sensor for converting a subject image (optical image) formed by the imaging lens 103 into an electric signal. The image sensor 104 in the present exemplary embodiment includes at least 4000 effective pixels or more horizontally and at least 2000 effective pixels or more vertically and is capable of outputting, for example, image data of 4 K format at 30 fps. The image sensor 104 includes a resister for setting a control parameter. The driving mode including the exposure time, exposure such as gain, reading timing, and decimation or addition operation is controllable by changing the setting of the resister. The image sensor 104 in the present exemplary embodiment includes an analog/digital (AD) conversion circuit therein and outputs digital image data of one frame at a timing synchronized with a vertical synchronization signal (hereinafter, sometimes referred to as “VD”) supplied from an external device. The VDs are consecutively supplied to enable output of a moving image at a predetermined frame rate as a normal driving mode. In the present exemplary embodiment, the VDs correspond to first timings at which an image of a target object is repeatedly captured, and an interval between the VDs corresponds to an interval between the first timings.

The driving mode of the image sensor 104 includes a driving mode (hereinafter, sometimes referred to as “high dynamic range (HDR) mode”) in which the setting of the exposure time is periodically changed for each VD based on the plurality of exposure times set to the resister. The driving mode is used so that a low exposure image of a shorter exposure time than an appropriate exposure time and a high exposure image of a longer exposure time than the appropriate exposure time are alternately acquired, and an image (hereinafter, “HDR image”) with an extended dynamic range is acquired by combining the acquired low and high exposure images. The gain setting can also be changed when the exposure time is changed. As the exposure setting, an appropriate exposure image can be set in combination with either one of the high exposure image and the low exposure image. The blocks that are configured to acquire an image in the present exemplary embodiment including the image sensor 104 correspond to an image capturing unit. The image sensor 104 is not limited to a single-plate image sensor including a Bayer-array color filter and can be a three-plate image sensor including image sensors respectively corresponding to red (R), green (G), and blue (B) included in the Bayer array. Further, the image sensor 104 can be configured to include not a color filter but a clear (white) filter, or an image sensor configured to receive infrared or ultraviolet light can be used.

An image processing unit 105 performs gain or offset correction, white balance correction, edge enhancement, noise reduction processing, etc. on the read image data as needed. The image processing unit 105 also performs predetermined pixel interpolation, resizing processing such as size reduction, and color conversion processing on the image data output from the image sensor 104. The image processing unit 105 performs predetermined computation processing using various signals, and a control unit 109 described below performs exposure control and focus detection control based on the acquired computation result. In this way, through-the-lens auto-exposure (AE) processing and automatic flash dimming and emission (EF) processing are performed. Further, the image processing unit 105 performs auto-focus (AF) processing. In the HDR mode, control can be performed such that a low exposure image with a short exposure time and a high exposure image with a long exposure time respectively undergo different image processing. One or some of the functions of the image processing unit 105 can be provided to the image sensor 104 to divide the processing load.

A combining unit 106 combines the two pieces of image data of the low and high exposure images processed by the image processing unit 105 to generate an HDR image. In the HDR image combining, each piece of image data is divided into a plurality of blocks, and combining processing is performed on the respective corresponding blocks. While the example in which two pieces of image data are acquired and combined is described in the present exemplary embodiment to simplify the description, the present exemplary embodiment is not limited to the example. For example, the target can be three or more pieces of image data. Although increasing the number of pieces of image data to be a target has a demerit that the image data acquisition time increases, a merit is also produced that the dynamic range in the HDR image is extended according to the number of images to be combined. In the cases in which no image combining is involved in a normal moving image mode, etc. other than the HDR mode, control can be performed such that the image data processed by the image processing unit 105 is directly input to a development processing unit 107. One or some of the functions of the combining unit 106 can be provided to the image sensor 104 to divide the processing load.

The development processing unit 107 compresses and encodes the image data processed by the combining unit 106 into a luminance signal, color difference signal, or predetermined moving image format such as a Moving Picture Experts Group(MPEG) format. The development processing unit 107 compresses and encodes a still image into a different format such as a Joint Photographic Experts Group (JPEG) format. The processed image data is output to the display unit 110 and displayed. The image data is stored in a recording unit (not illustrated) as needed. The display unit 110 can be included in the PC 101 or can be provided as a separate unit.

A memory 108 temporarily stores still image data. The memory 108 has sufficient storage capacity to record image data of one or more frames and records the image data processed by the combining unit 106. In the case in which the image sensor 104 is driven in the moving image mode to acquire a moving image from a plurality of pieces of image data, the image data is acquired at 30 fps to 60 fps. In order for smooth reproduction or to obtain storage capacity, each piece of image data is irreversibly compressed and encoded by the development processing unit 107 and then stored in a predetermined moving image format. For this reason, in the cases in which image data of one frame is extracted from the compressed and encoded moving image as still image data, sufficient gradations may not be obtained or high-frequency components of the image are eliminated to lack precision, so that the extracted image data can be not suitable. Furthermore, the image quality can deteriorate due to noise associated with the compression and encoding processing. To avoid such drawbacks, the image data that is to be processed by the development processing unit 107 is stored in the memory 108 so that not only a moving image is acquired but also high-quality still image data is acquired. The memory 108 is a ring buffer, and old image data is overwritten with new image data to store the new image data so that a plurality of images is repeatedly stored with less storage capacity. While the memory 108 is configured to store the image data processed by the combining unit 106 in the present exemplary embodiment, the image data can be processed by the image processing unit 105 and then stored. The memory 108 also stores various types of image data acquired by the image capturing unit and data to be displayed on the display unit 110. The memory 108 has sufficient storage capacity to store not only the image data but also audio data. The memory 108 can also be used as a memory (video memory) for image display.

The control unit 109 controls various computations and the entire image capturing apparatus 102. In order to control the entire image capturing apparatus 102, the control unit 109 includes a central processing unit (CPU) for comprehensively controlling each component and sets various setting parameters, etc. to each component. The control unit 109 executes a program recorded in the memory 108 described above to realize a process in the present exemplary embodiment described below. The control unit 109 includes a system memory and, for example, a random access memory (RAM) is used. Constant and variable numbers for the operations of the control unit 109, a program read from a non-volatile memory, etc. are loaded into the system memory. The non-volatile memory is an electrically erasable/recordable memory and, for example, a flash memory or the like is used. In the non-volatile memory, the constant numbers for the operations of the control unit 109, program, etc. are stored. As used herein, the term “program” refers to a program for executing a flowchart described below in the present exemplary embodiment. The control unit 109 includes a system timer and measures the time for use in various types of control and the time specified by a built-in clock. The control unit 109 can include a hardware circuit including a reconfigurable circuit besides the CPU for executing the programs.

The control unit 109 includes a communication unit (not illustrated) and is connected with the PC 101, which is an external apparatus, based on a wired communication port or a wireless communication unit. The image capturing apparatus 102 can include an operation unit for changing the mode, etc.

The PC 101 in the present exemplary embodiment controls the examination table 100 and the blocks of the image capturing apparatus 102 and supplies a signal (hereinafter, sometimes referred to as “trigger signal”) for controlling the timings of repeat operations. Especially, the examination table 100 includes a cutter for cutting an examination object which is a target object for use in examination, and the repeat operation of the cutter is controlled and the speed of the cutter is detected. Further, an image capturing timing of the image sensor 104 and a still image data retrieval timing are controlled with respect to the control unit 109 of the image capturing apparatus 102.

FIG. 2 illustrates a configuration of the image capturing system in the present exemplary embodiment. There are an examination stage 200, a cutter 201, and an examination object 202. The examination stage 200, the cutter 201, and the examination object 202 are provided to the examination table 100, and the examination object 202 is, for example, a test sample such as a living thing or plant. More specifically, the examination object 202 placed on the examination stage 200 can be cut with the cutter 201. The cutter 201 is rotatable with respect to a predetermined shaft, and the position of the examination stage 200 or the cutter 201 for cutting the examination object 202 is changeable according to the rotation of the cutter 201. Specifically, the cutter 201 is rotated at a constant period so that the examination object 202 can be repeatedly cut to enable continuous observation/analysis of a cross section of the examination object 202. The cutter 201 in the present exemplary embodiment is a mere example for processing the examination object 202 as a target and is not limited to the cutting operation and is also suitable for an operation repeatedly applied to the examination object 202. For example, the cutter 201 is applicable to a case of pressing, heating, cooling, adding a reagent, etc. using a predetermined apparatus.

The image capturing apparatus 102 is fixed to connect a focal point with respect to the cross section of the examination object 202 placed on the examination stage 200. The PC 101 is connected with the examination table 100 and the image capturing apparatus 102 via a wired cable and controls the vertical position of the examination table 100 for cutting without causing the cutter 201 to miss the examination object 202. After the examination object 202 is cut, the cutter 201 is controlled to move vertically downward to ensure that the examination object 202 is cut in the next rotation. The image capturing apparatus 102 is controlled to control a timing to capture an image of how the examination object 202 is cut. In the present exemplary embodiment, the image capturing apparatus 102 is driven in the HDR mode, and a combined HDR image is output as moving image data. Still image data is output in synchronization with a trigger signal that occurs in synchronization with a cutting timing of the examination object 202. While the output timing of each piece of image data is controllable by supplying a trigger signal from the PC 101, the timing can also be controlled such that image data is autonomously output at predetermined constant timings.

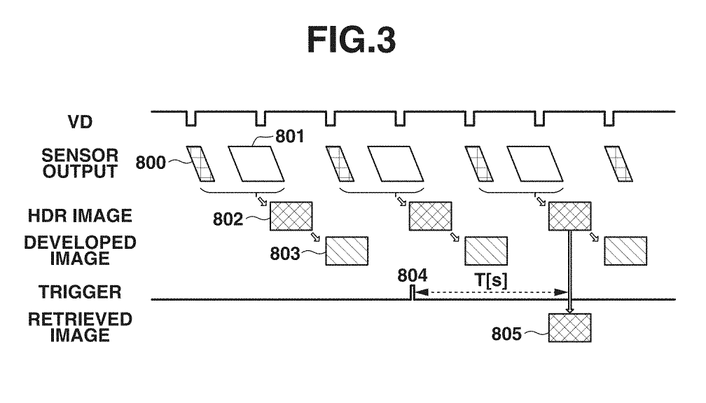

FIG. 3 illustrates a timing chart of an image capturing operation in the image capturing system in the present exemplary embodiment. The image sensor 104 is set to drive in the HDR mode, and repeatedly and alternately outputs a low exposure image 800 of a short exposure time and a high exposure image 801 of a long exposure time in synchronization with the VD. Two consecutive pieces of output image data as a set are combined by the combining unit 106 to generate an HDR image 802. The HDR image combining is performed at a timing immediately after the low exposure image 800 and the high exposure image 801 are acquired in this order. The reason is as follow. Specifically, in the case in which the reading timing is fixed with respect to the VD for each image data as illustrated in FIG. 3, the acquisition timings of the high exposure image and the low exposure image are temporally separated, so that it is not suitable to combine the images acquired in this order. The moving image data having undergone the development processing performed by the development processing unit 107 is output. The output image data can be stored in the image capturing apparatus 102 or retrieved into the PC 101 via the wired cable. When a trigger signal 804 is output from the PC 101 and received by the control unit 109, still image data 805 is retrieved. The image data that is actually retrieved is the image data acquired at the next timing following the output timing of the trigger signal. The time T in FIG. 3 indicates the time from the output of the trigger signal to the image retrieval. In the flowchart in FIG. 3, while the HDR image immediately after the output of the trigger signal 804 is stored on the memory 108, the development processing by the development processing unit 107 is already started and the operation of capturing the next low exposure image is also already started. For this reason, at a timing specified in FIG. 3, when the immediate HDR image is retrieved, the image data on the memory 108 is overwritten with the development processing result or the next low exposure image. Accordingly, the HDR image retrieval is performed at the next timing. While the operation of generating an HDR image from two consecutive pieces of image data as a set is illustrated in FIG. 3, an intermediate exposure image can be acquired to use three or more images as a set.

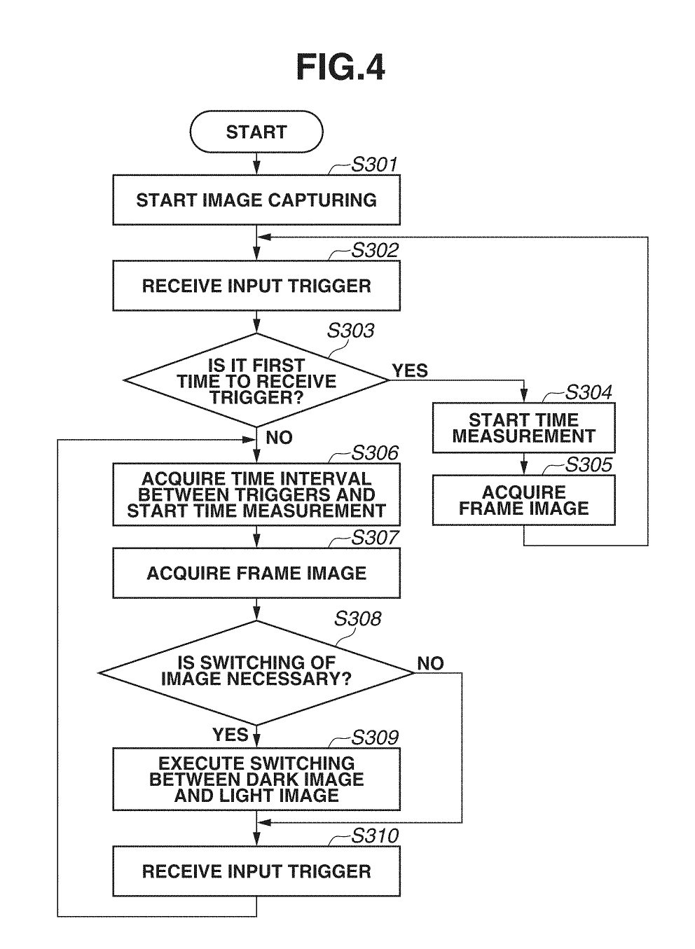

The following describes an examination operation on the examination object 202, which is an operation in the present exemplary embodiment, with reference to the flowchart in FIG. 4. The process illustrated in the flowchart is mainly performed by the control unit 109 of the image capturing apparatus 102. In synchronization with the start of the operation of the image capturing apparatus 102, the PC 101 starts controlling the examination table 100. Specifically, as the PC 101 performs start control, the rotation operation of the cutter 201 and initialization of the relative positions of the cutter 201 and the examination object 202 are performed. The rotation speed of the cutter 201 is not stable at the time of the start of the rotation operation, so that the examination object 202 is controlled to be positioned to not come in contact with the cutter 201, and the process in the flowchart is started after a time passes that is sufficient enough for the speed control to be performed to adjust the cutter speed to a uniform rotation.

In step S301, the control unit 109 starts an image capturing operation based on an operation start instruction from the PC 101. Specifically, the control unit 109 performs driving mode parameter setting and exposure condition setting with respect to the image sensor 104 and starts supplying the VD and clock for operation. When the operation is started, image data acquired by the image capturing operation is output at a predetermined frame rate. The image sensor 104 in the flowchart is driven in the HDR mode and outputs the HDR image generated by combining the low exposure image and the high exposure image as illustrated in FIG. 3. Meanwhile, in response to the start of step S301, the PC 101 communicates with the examination table 100 and adjusts the height of the cutter 201 with respect to the examination object 202 to the cutting position at which the examination object is to be cut. The processing proceeds to step S302.

In step S302, the control unit 109 receives a trigger signal from the PC 101. The trigger signal is associated with the rotation timing of the cutter 201 of the examination table 100. The processing proceeds to step S303.

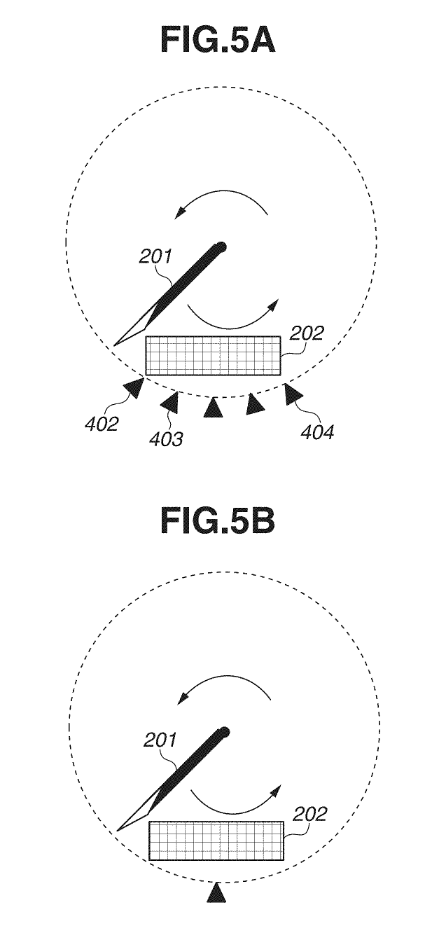

The following describes an example of the rotation of the cutter 201 with respect to the examination object 202 and the operation relating to the occurrence timing of the trigger signal, with reference to FIGS. 5A and 5B. For the purpose of description, FIGS. 5A and 5B illustrate how the cutter 201 is rotated with respect to the examination stage 200 when viewed from the top. As an example, FIG. 5A illustrates a case of acquiring a plurality of pieces of still image data to observe how the examination object 202 is cut at a plurality of positions during one rotation of the cutter 201. Accordingly, when the cutter 201 is rotated, the examination object 202 is cut, and the PC 101 supplies a trigger signal to the image capturing apparatus 102 in synchronization with a timing at which the cutter 201 passes a position (trigger point) 402, 403, etc. each specified by a black triangle. While the intervals between the trigger points are equal intervals in the present exemplary embodiment, the intervals do not have to be equal intervals. Specifically, the occurrence intervals of the trigger signals can include a plurality of types of intervals. As described above, the occurrence timings of the trigger signals are limited to the cutting timings of the examination object 202 to prevent retrieval of unnecessary still image data. While the trigger signals are generated by the PC 101 which controls the examination table 100 in the present exemplary embodiment, the configuration is not limited to this example and, for example, a photosensor, etc. can detect the physical position of the cutter 201 to use the detection result directly as a trigger signal. In this case, the trigger signal can be input not via the PC 101 but directly to the image capturing apparatus 102.

As another example, FIG. 5B illustrates a case of acquiring a single piece of still image data to observe how the examination object 202 is cut once during one rotation of the cutter 201. Accordingly, the intervals of the trigger signal occurrence timings in the first and second rotations are equal intervals.

The following is a continuation of the description of FIG. 4. In step S303, the control unit 109 counts the number of times a trigger signal has been received since the start of the operation, and determines what number the trigger signal received in immediately-previous step S302 is. If the control unit 109 determines that this is the first time to receive a trigger signal (YES in step S303), the processing proceeds to step S304. On the other hand, if the control unit 109 determines that this is the second or subsequent time to receive a trigger signal (NO in step S303), the processing proceeds to step S306.

In step S304, the control unit 109 starts measuring the time that has passed since the input of the first trigger signal using a time measurement unit. The measured time is stored in the memory 108, etc. and updated as needed. The processing proceeds to step S305.

In step S305, the control unit 109 acquires image data from the image sensor 104 at a predetermined frame rate, and the processing returns to step S302 to wait for a next trigger signal to be input.

In step S306, the control unit 109 detects a time interval T1 between the reception of the trigger signals based on the result of the time measurement by the time measurement unit. Further, the control unit 109 calculates a time Tvd from the last-received trigger signal to the nearest VD. The control unit 109 initializes the time Tvd and the elapsed time measurement at the time measurement unit and then restarts time measurement. The processing proceeds to step S307. In the present exemplary embodiment, the time interval T1 between the reception of the trigger signals corresponds to an interval between second timings.

In step S307, the control unit 109 acquires image data from the image sensor 104 at a predetermined frame rate, and the processing proceeds to step S308.

In step S308, the control unit 109 estimates an occurrence timing of the next trigger signal based on the time T1, which corresponds to the interval between the occurrences of the previous trigger signals, and the time Tvd. Then, the control unit 109 determines whether image data to be output from the image sensor 104 at the estimated trigger signal occurrence timing is a low exposure image or a high exposure image. Using the determination result, the control unit 109 determines whether the image data acquired at a predetermined timing needs to be switched between a low exposure image and a high exposure image. If the control unit 109 determines that the switching is necessary (YES in step S308), the processing proceeds to step S309. On the other hand, if the control unit 109 determines that the switching is not necessary (NO in step S308), the processing proceeds to step S310 to wait for a next trigger signal to be input.

An example of the determination method in step S308 is as follows. Specifically, as illustrated in FIG. 5B, in the case in which the interval between the trigger signals is constant, the time T1 is also constant. Using this fact, the value obtained by subtracting the time Tvd from the time T1 after a predetermined trigger signal is divided by the interval between the VDs to obtain the quotient. Then, the determination is performed by determining whether the integer part of the quotient is an even number or an odd number. Specifically, in the case in which the image at the time of occurrence of a predetermined trigger signal is a high exposure image, a high exposure image is output from the image sensor 104 at the estimated trigger signal occurrence timing if the integer part of the quotient is an even number, whereas a low exposure image is output from the image sensor 104 at the estimated trigger signal occurrence timing if the integer part of the quotient is an odd number. On the other hand, in the case in which the image at the time of occurrence of the predetermined trigger signal is a low exposure image, a low exposure image is output from the image sensor 104 at the estimated trigger signal occurrence timing if the integer part of the quotient is an even number, whereas a high exposure image is output from the image sensor 104 at the estimated trigger signal occurrence timing if the integer part of the quotient is an odd number. As illustrated in FIG. 5A as another example, in the case in which there is a plurality of trigger signal intervals, a plurality of trigger signal time intervals is stored, and the periodicity is detected. In FIG. 5A, the interval between the trigger points 402 and 403 is the time T1, and the interval between the trigger points 404 and 402 is the time T2. Estimation of four trigger signal output timings is performed using the time T1, and then estimation of one output timing is performed using the time T2. Performing the control in this way enables estimation with great accuracy. While the number of times and timings of the time T1 are settable from the PC 101, the number of times and timings of the time T1 can be estimated by machine learning using deep learning, etc. while the operations of the flowchart in FIG. 4 are repeated again and again. In the example illustrated in FIG. 5A, the time T1 is so short that prediction is not always necessary. In such a case, the prediction can be performed using only the time T2 between the trigger points 404 and 402, which is a relatively long time interval. Specifically, the prediction is performed in the case in which the trigger signal interval is longer than a predetermined time so that the computation load is reduced. It is difficult to make the rotation operation of the cutter 201 completely constant, and variation occurs with respect to the time of occurrence of a trigger signal. Accordingly, in order to improve the accuracy of the time T1 for use in prediction, time T1ave obtained as a result of performing statistical processing such as average calculation from a plurality of results of calculation of the time T1 can be used in estimating the timing of the next trigger signal.

In step S309, the control unit 109 executes switching an image to be acquired at the next VD timing between a low exposure image and a high exposure image. More specifically, in the case in which it is estimated that the image sensor 104 is to output a low exposure image at the time of occurrence of the next trigger signal that is predicted in step S308, an operation of switching the acquisition order of a low exposure image and a high exposure image is performed. This is because the acquisition of combined HDR image data is performed after the output of the high exposure image, and the time from the trigger signal occurrence to the HDR image data acquisition is reduced by switching the order of image data acquisition.

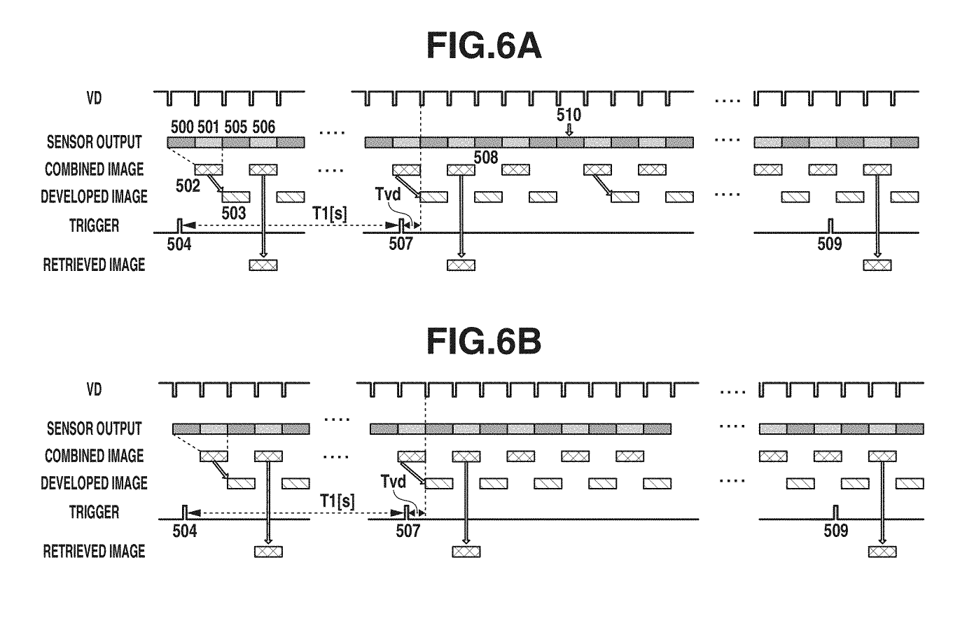

The following describes details of the operation in step S309, with reference to FIGS. 6A and 6B. In FIGS. 6A and 6B, the VD corresponding to the reading period of the image sensor 104, the output timing of image data from the image sensor 104, the output timing of a HDR image combined by the combining unit 106, and the output timing of image data on which development processing is performed by the development processing unit 107 are illustrated. Further, trigger signals each of which is a timing to retrieve still image data into the PC 101 and output timings of the retrieved images are illustrated.

FIG. 6A illustrates the operation in which the acquisition order of a low exposure image and a high exposure image is switched in step S309, whereas FIG. 6B illustrates the operation in which the acquisition order of a low exposure image and a high exposure image is not switched in step S309. In both cases, the control unit 109 sets a parameter for acquiring a low exposure image with respect to the image sensor 104 and starts reading in synchronization with the VD to read low exposure image data 500. Thereafter, the control unit 109 sets a parameter for acquiring a high exposure image with respect to the image sensor 104 and starts reading in synchronization with the VD to read high exposure image data 501. The combining unit 106 combines the low exposure image 500 and the high exposure image 501 to generate image data 502 for one HDR image. The development processing unit 107 performs development processing on the sequentially acquired HDR images and converts the HDR images into a moving image format such as MPEG format to generate developed image data 503. Continuous images as a moving image are generated from the generated developed image data 503 on the display unit 110. The HDR image data generated at the next low exposure image acquisition timing following the input timing of a trigger signal 507 is output as a retrieved image.

In the example in FIG. 6A, T1=105 ms, VD interval=8.3 ms, and Tvd=3.0 ms. In this case, (105 ms-3.0 ms)/8.3 ms≈12, which is an even number. In this case, the image data estimated in step S308 is a high exposure image at the time of output of the trigger signal 507, so that a low exposure image is to be output at the time of generation of a next trigger signal 509.

In the present exemplary embodiment, the HDR image generated by combining the low exposure image and the high exposure image following the trigger signal occurrence timing is retrieved as a retrieved image, and this makes it possible to reduce the time lag at the time at which the output of the image sensor 104 is a high exposure image at the time of trigger signal output.

Accordingly, in the case illustrated in FIG. 6A, it is estimated that the output of the next trigger signal 509 is a low exposure image, so that the acquisition timings of a low exposure image and a high exposure image are switched at a predetermined timing 510. The predetermined timing 510 can be any timing between trigger signal occurrences. In one embodiment, the timing is not a timing that is immediately before an occurrence timing of the next trigger signal 509.

In the example in FIG. 6B, T1=100 ms, VD interval=8.3 ms, and Tvd=3.0 ms, and (100 ms-3.0 ms)/8.3 ms≈11, which is an odd number. In this case, the image data estimated in step S308 is a high exposure image at the time of output of the trigger signal 507, so that the output at the time of generation of the next trigger signal 509 is a high exposure image. For this reason, the operating of switching the acquisition order of a low exposure image and a high exposure image is not performed.

As described above, the operation of the image sensor 104 at the next trigger signal occurrence timing is estimated from the trigger signal occurrence interval, and the acquisition order is controlled based on whether the image data at the next trigger signal occurrence timing is a high exposure image or a low exposure image. In this way, the time lag from the trigger signal occurrence to the image retrieval is reduced to realize further stabilization.

While the image capturing apparatus 102 continuously acquires images at a predetermined frame rate, if control of an external apparatus performed in not synchronization with the acquisition is repeated at predetermined intervals, periodic waviness occurs. The waviness varies and can be a shift in timing, viewing angle, or the cutter 201 and becomes noise that disturbs appropriate examination of the examination object 202. In this case, an application of the present exemplary embodiment reduces the waviness caused by a shift in operation of a device (e.g., the cutter 201) that operates in not synchronization with the image capturing apparatus 102.

In order to detect the first trigger signal occurrence interval, preliminary rotation can be performed to rotate the cutter 201 without cutting the examination object 202. Further, control can be performed by setting a preliminary trigger point before a cutting point so that the first trigger point can also be estimated.

Further, the PC 101 monitors the rotation speed and corrects the trigger positions as needed in order to adjust an actual cutting position to a desired trigger position. The speed can be output to the control unit 109 of the image capturing apparatus 102 to perform control such that a predicted trigger position is corrected based on a change in the speed of the cutter 201. The next trigger signal timing and the image capturing timing can be adjusted not only by switching the acquisition order of a low exposure image and a high exposure image but also by adjusting the acquisition interval (frame rate).

In the case in which there is a plurality of trigger positions in one rotation as in FIG. 5A, control can be performed such that the predicted trigger time T1 is set, and if no trigger signal is input although the set time T1 passes, the time measurement is stopped and the time from the next trigger point is measured again. Further, in the case in which the plurality of trigger signal intervals is set as T1 and T2, control can be performed such that if no trigger signal is input although the shorter time T1 in the measurement time passes, estimation is performed again using the longer time T2 as the next trigger signal occurrence timing. The present exemplary embodiment is not limited to those examples described above, and estimation can be performed a plurality of times in order to improve estimation accuracy.

As described above, the retrieval interval time measurement is performed to estimate the next trigger signal occurrence timing, and whether the image to be read at the timing is a low exposure image or a high exposure image is estimated. In this way, the time from the trigger signal occurrence to the actual retrieval timing is reduced. The next trigger signal occurrence timing is estimated so that the user does not need to set the timing and the system versatility is extended. For example, the adjustment of the rotation of the cutter 201 and the image capturing timing of the image capturing apparatus 102 becomes unnecessary to enable free setting of the rotation speed of the cutter 201 and the exposure condition of the image capturing apparatus 102.

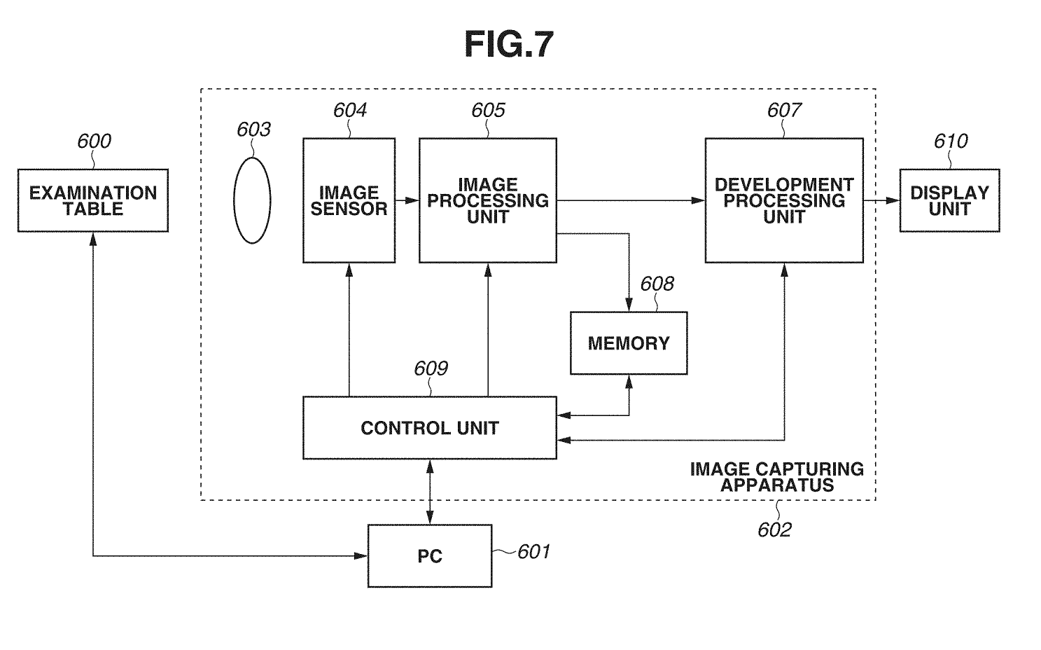

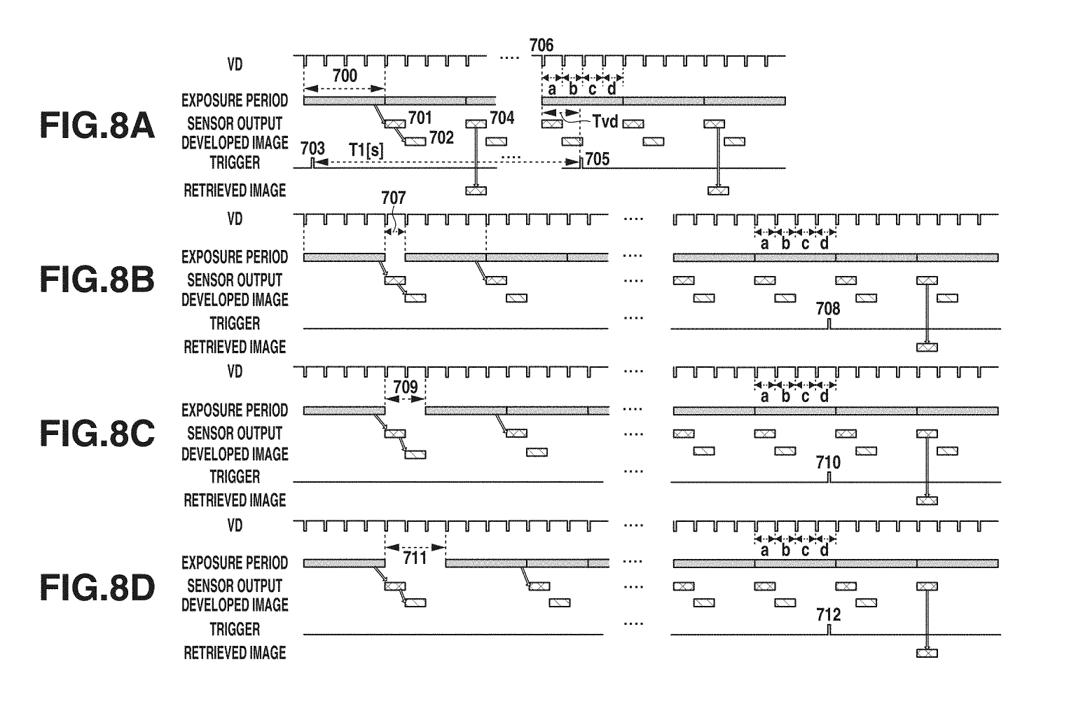

In the first exemplary embodiment, the operation in the HDR driving mode in which a plurality of images is combined to expand the dynamic range is described. In the HDR driving mode, a plurality of images is to be acquired to acquire one HDR image, so that the frame rate decreases dependently on the number of combined images. Specifically, if a trigger signal occurs immediately before a start of image data acquisition, the time lag of image data acquisition is minimized, whereas if a trigger signal occurs immediately after a start of image data acquisition, a delay corresponding to the frame rate occurs. This phenomenon is not limited to the HDR driving mode and the same issue occurs in, for example, a so-called slow shutter driving mode in which the frame rate is decreased to increase the exposure time in the case of capturing an image of a low luminance subject. The following describes an application to the control of the slow shutter driving mode in a second exemplary embodiment of the disclosure, with reference to FIGS. 7, 8A, 8B, 8C, and 8D.

FIG. 7 is a detailed block diagram illustrating a configuration in the second exemplary embodiment. The configuration corresponds to the configuration in FIG. 1 in the first exemplary embodiment. The configuration in FIG. 7 is different from the configuration in FIG. 1 in that a block corresponding to the combining unit 106 is not included and a memory 608 is configured to store image data from an image processing unit 605.

The following describes details of a timing chart that specifies a feature of the present exemplary embodiment, with reference to FIGS. 8A, 8B, 8C, and 8D. A PC 601 starts rotation of the cutter 201 of an examination table 600 at a constant velocity and controls an image capturing apparatus 602 along with the operation of the cutter 201 to start image capturing. In FIGS. 8A, 8B, 8C, and 8D, the VD corresponding to the reading period of an image sensor 604, the output timing of image data from the image sensor 604, and the output timing of image data on which development processing is performed by a development processing unit 607 are illustrated, as in FIGS. 6A and 6B in the first exemplary embodiment. Further, trigger signals each of which is a timing to retrieve still image data into the PC 601 and output timings of the retrieved images are illustrated.

FIG. 8A illustrates the timings at the start of image capturing. In the present exemplary embodiment, the control of the slow shutter driving mode is performed such that a long exposure corresponding to four VD periods as specified by a time 700 in FIGS. 8A, 8B, 8C, and 8D is performed and the reading from the image sensor 604 is performed every four VD periods. Accordingly, the frame rate is decreased to one fourth.

A control unit 609 sets a parameter for the slow shutter driving mode with respect to the image sensor 604 and sets an exposure time of four VD periods. As illustrated in FIG. 8A, when the exposure time of four VD periods has passed, image data 701 is read from the image sensor 604 in one VD period. The image data read from the image sensor 604 is transferred to the image processing unit 605, and the image processing unit 605 performs various image processing such as edge enhancement and black level correction on the image data. The development processing unit 607 performs development processing on the image data processed by the image processing unit 605 and outputs image data 702 having undergone the development processing. The foregoing operation is repeated so that moving image data is acquired.

In the slow shutter driving mode, a trigger signal is input to the control unit 609 in synchronization with a cutting timing of the examination object 202, as in the first exemplary embodiment. In FIG. 8A, when the control unit 609 detects input of a trigger signal 703, the control unit 609 performs control to retrieve image data 704 output from the image sensor 604 after the next exposure as a retrieved image into the memory 608. Even in such a system, a significant delay can occur with respect to an actual timing to retrieve intended image data depending on the timing of input of the trigger signal to the control unit 609, as in the first exemplary embodiment. Especially in the cases in which the examination object 202 is to be observed in a low-illuminance environment, the number of VDs to be used as an exposure time increases, so the possibility of a delay increases. In order to eliminate the influence of dark current that occurs due to an increase in exposure time, the processing of acquiring a black image and subtracting the black image from the image data can be performed. In this case, control can be performed such that the black image acquisition timing and the trigger signal occurrence timing do not overlap using the operation in the first exemplary embodiment.

The present exemplary embodiment is characterized in that the input timing of the next trigger signal is estimated in advance and the slow shutter exposure start timing is controlled using the estimation result, as in the operation in the flowchart in FIG. 4 in the first exemplary embodiment. More specifically, the time measurement is started in synchronization with the input of a trigger signal, and the time to the next trigger signal is measured, as in the first exemplary embodiment. As illustrated in FIG. 8A, the time T1 from the trigger signal 703 to a trigger signal 705 is acquired, and the time Tvd from the VD at the time of the start of exposure to the trigger signal 705 is acquired. Further, the VD timing at which the next trigger signal is to be input among the four VD timings (timings a, b, c, and d in FIG. 8A) is estimated from the acquired time.

If a trigger signal is input at a timing d of the VD, a time lag in the retrieval of still image data is reduced.

In an example of an estimation method, first, the time T1 is added to the time Tvd to calculate the predicted time (T1+Tvd) from the VD 706 at the time of start of exposure to the next trigger position. Further, the predicted time is divided by the VD interval. It is estimated that the trigger is to be output at the position a in the case in which the integer part of the quotient is 4n, at the position b in the case in which the integer part of the quotient is 4n +1, at the position c in the case in which the integer part of the quotient is 4n+2, or at the position in the case in which the integer part of the quotient is 4n+3 (n is an integer).

In the example in FIG. 8A, T1=350 ms, Tvd=11 ms, and VD interval=8.3 ms, and 350 ms+11 ms=361 ms.

Further, 361 ms/11 ms≈43=4×10 +3(4n+3), so that the estimated trigger signal input timing is the timing d.

As described above, in the case in which the predicted position of the next trigger is the position d, the release time lag is minimized, so that the reading is continued. Further, in the case in which the predicted position of the next trigger is the position c, the next trigger position is adjustable to the position d by delaying the exposure start (reading start) of the image sensor 604 by one VD, as in the timing chart in FIG. 8B. Similarly, in the case in which the predicted position of the next trigger is the position b, the next trigger position is adjustable to the position d by delaying the exposure start (reading start) of the image sensor 604 by two VDs, as in the timing chart in FIG. 8C. Further, in the case in which the predicted position of the next trigger is the position a, the next trigger position is adjustable to the position d by delaying the exposure start (reading start) of the image sensor 604 by three VDs, as in the timing chart in FIG. 8D.

As described above, the time lag is minimized by changing the exposure start timing and the reading timing from the image sensor 604 according to the trigger signal timing predicted from the acquired time. While the operating of changing the reading timing from the image sensor 604 is described as an example in the present exemplary embodiment, in the cases in which the exposure is changed by changing the exposure start timing, control can also be performed to change the gain setting and aperture value.

The exemplary embodiment is described above in which the operation of estimating a more suitable image data retrieval timing in the HDR driving mode is applied to the slow shutter driving mode. The aspect of the embodiments is also applicable to a case of control other than the driving modes. A time lag of an image data retrieval timing at the next trigger position is reduced by measuring the time between retrieval timings, acquiring the positional relationship between the next trigger position and the reading image position, and changing the exposure start timing.

Even in a driving mode other than the HDR driving mode and the slow shutter driving mode, a similar benefit is produced by applying an exemplary embodiment of the present invention to a scene in which the frame rate decreases.

The following describes another exemplary embodiment. The image sensor 104 and the image capturing apparatus 102 described in the above-described exemplary embodiments are applicable to various applications. For example, the image sensor 104 and the image capturing apparatus 102 described in the above-described exemplary embodiments are suitable for use in capturing an image of an examination object that is moved to the image capturing apparatus 102 by being conveyed by a linear belt conveyer, etc., such as factory automation (FA) applications, instead of capturing an image of an examination object fixed to the image capturing apparatus 102. For example, image capturing is performed at an appropriate timing regardless of whether the examination object conveyance interval is constant, by setting a trigger point in synchronization with a conveyance timing and predicting a next conveyance timing of an examination object.

The image sensor 104 can be used in sensing visible light as well as light other than visible light, such as infrared light, ultraviolet light, and X-rays. The image capturing apparatus 102 is representatively a digital camera but is also applicable to a mobile phone with a camera, such as a smartphone, a monitoring camera, a game device, etc. Further, the image capturing apparatus 102 is also applicable to a medical device configured to capture endoscopic images and blood vessel images, a beauty device for observing a skin and scalp, and a video camera for capturing images in sports and action moving images. The image capturing apparatus 102 is also applicable to a traffic-purpose camera such as a traffic monitor or event data recorder, an academic-application camera such as an astronomical observation camera or sample observation camera, a household appliance equipped with a camera, machine vision, etc. Especially, the machine vision is not limited to a robot in a factory, etc. and can also be used in agricultural and fishing industries.

The configurations of the image capturing apparatus described in the above-described exemplary embodiments are mere examples, and the image capturing apparatus to which an exemplary embodiment of the disclosure is applicable is not limited to the configuration illustrated in FIG. 1. The circuit configurations of the respective components of the image capturing apparatus are not limited to those illustrated in the drawings.

The aspect of the embodiments is also realizable by a process in which a program for realizing the above-described functions is supplied to a system or apparatus via a network or storage medium and one or more processors of a computer of the system or apparatus read and execute the program. The aspect of the embodiments is also realizable by a circuit (e.g., application-specific integrated circuit (ASIC)) that realizes one or more functions.

The above-described exemplary embodiments are mere illustrations of specific examples of implementation of the disclosure and are not intended to limit the technical scope of the invention. Specifically, the disclosure is implementable in various forms without departing from the spirit or main features of the invention.

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-243011, filed Dec. 19, 2017, which is hereby incorporated by reference herein in its entirety.

What is claimed is:

1. An apparatus configured to capture an image of a target object repeatedly at a first timing, the apparatus comprising:
an image sensor configured to acquire image data of the target object;
a control unit configured to control driving of the image sensor; and
an acquisition unit configured to acquire a second timing at which the target object is to be processed repeatedly,
wherein the control unit controls the driving of the image sensor based on an interval between first timings and an interval between second timings.

2. The apparatus according to claim 1, wherein the control unit includes an estimation unit configured to estimate a next second timing based on an interval between previous second timings.

3. The apparatus according to claim 2, wherein the control unit generates a moving image based on the image data acquired at the first timing, and the control unit generates a still image based on the image data acquired at the second timing.

4. The apparatus according to claim 1, further comprising a combining unit configured to combine a plurality of pieces of image data,
wherein the control unit periodically sets a different exposure for the image data to the image sensor, and
wherein the combining unit generates image data with an extended dynamic range by combining the plurality of pieces of image data for which the different exposure is set.

5. The apparatus according to claim 4, wherein the different exposure includes a higher exposure than an appropriate exposure and a lower exposure than the appropriate exposure.

6. The apparatus according to claim 4, wherein the control unit switches the exposure set to the image sensor based on the interval between the first timings and the interval between the second timings.

7. The apparatus according to claim 1,
wherein the first timing is a vertical synchronization signal, and
wherein the control unit controls the driving of the image sensor to acquire the image data across a plurality of vertical synchronization signals.

8. The apparatus according to claim 7, wherein the control unit switches an exposure start timing set to the image sensor based on the interval between the first timings and the interval between the second timings.

9. The apparatus according to claim 1, wherein the interval between the second timings includes a plurality of types of time intervals.

10. A method comprising
capturing an image of a target object repeatedly at a first timing;
acquiring image data of the target object by an image sensor;
controlling driving of the image sensor; and
acquiring a second timing at which the target object is to be processed repeatedly,
wherein the controlling controls the driving of the image sensor based on an interval between first timings and an interval between second timings.

11. The method according to claim 10, wherein the controlling includes estimating a next second timing based on an interval between previous second timings.

12. The method according to claim 10, further comprising combining a plurality of pieces of image data,
wherein the controlling periodically sets a different exposure for the image data to the image sensor, and
wherein the combining generates image data with an extended dynamic range by combining the plurality of pieces of image data for which the different exposure is set.

13. The method according to claim 10,
wherein the first timing is a vertical synchronization signal, and
wherein the controlling controls the driving of the image sensor to acquire the image data across a plurality of vertical synchronization signals.

14. The method according to claim 10, wherein the interval between the second timings includes a plurality of types of time intervals.

15. A computer readable storage medium storing a computer-executable program of instructions for causing a computer to perform a method comprising:
capturing an image of a target object repeatedly at a first timing;
acquiring image data of the target object by an image sensor;
controlling driving of the image sensor; and
acquiring a second timing at which the target object is to be processed repeatedly,
wherein the controlling controls the driving of the image sensor based on an interval between first timings and an interval between second timings.

16. The computer readable storage medium according to claim 15, wherein the controlling includes estimating a next second timing based on an interval between previous second timings.

17. The computer readable storage medium according to claim 15, further comprising combining a plurality of pieces of image data,
wherein the controlling periodically sets a different exposure for the image data to the image sensor, and
wherein the combining generates image data with an extended dynamic range by combining the plurality of pieces of image data for which the different exposure is set.

18. The computer readable storage medium according to claim 15,
wherein the first timing is a vertical synchronization signal, and
wherein the controlling controls the driving of the image sensor to acquire the image data across a plurality of vertical synchronization signals.

19. The computer readable storage medium according to claim 15, wherein the interval between the second timings includes a plurality of types of time intervals.
